(19) United States
(12) Patent Application Publication
(10) Pub. No.: US 2011/0012858 A1
(43) Pub. Date: Jan. 20, 2011

(54) DUAL SCREEN DISPLAY SYSTEM

(75) Inventors: Christopher John Brookes, Richmond (CA); Valerio Cometti, S. Dona' D Piave (IT)

Correspondence Address: MCNEES WALLACE & NURICK LLC, 100 PINE STREET, P.O. BOX 1166, HARRISBURG, PA, 17108-1166, US

(73) Assignee: CANOVA TECHNOLOGIES LIMITED, Surrey, BC (CA)

(21) Appl. No.: 12/933,986

(22) PCT Filed: Jun. 11, 2009
(86) PCT No.: PCT/US09/47045

§ 371 Date: Sep. 22, 2010

Related U.S. Application Data
(60) Provisional application No. 61/060,889, filed on Jun. 12, 2008.

(51) Int. Cl. G06F 3/041; G09G 5/00

(52) U.S. Cl. 345/173; 345/1.3

(57) ABSTRACT

A display system is provided with a first display device having a first screen and a second display device having a second screen. The display system also includes a hinging system connecting the first display device and the second display device. The hinging system is configured to permit the second display device to rotate independently of the first display device.

### CROSS REFERENCE TO RELATED APPLICATIONS

This application claims the benefit of U.S. Provisional Application 61/060,889, filed Jun. 12, 2008.

### BACKGROUND

The application generally relates to a dual screen display system. The application relates more specifically to a dual screen display system having a hinging system that permits the dual screens to be arranged in multiple positions.

Many dual screen display systems use a center hinge arrangement between the two screens. The center hinge arrangement locks the two screens together and limits the positions of the two screens relative to one another. The use of the center hinge permits the screens to be moved between a first position where the screens are stacked on top of one another and a second position where the screens are positioned side-by-side, similar to the movements associated with opening and closing a book. One drawback to the use of the center hinge is that it prevents the screens from being arranged in a position where one screen can be positioned to show information to one or more people such as during a presentation while the other screen can still be utilized by the user of the system giving the presentation.

Therefore what is needed is a hinging system for a dual screen display system that permits the two screens in the dual screen display system to be quickly and easily positioned into a variety of different positions, including positions that require the one screen to be rotated independent of the other screen.

### SUMMARY

The present application relates to a display system including a first display device having a first screen and a second display device having a second screen. The display system also includes a hinging system connecting the first display device and the second display device. The hinging system includes a first member connected to the first display device and a second member having a first end and a second end opposite the first end. The first member is configured to rotate relative to the first display device. The second member is connected to the first member at the first end and the second member is connected to the second display device at the second end. The second member is configured to rotate relative to the first member. The second display device is configured to rotate relative to the second member. The hinging system is configured and positioned to permit the second display device to rotate independently of the first display device.

The present application further relates to a system to connect a first display device to a second display device including a first member connectable to a first display device with a first connector and a second member connected to the first member with a second connector. The first connector is configured and positioned to permit the first member to rotate relative to the first display device. The second connector is configured and positioned to permit the second member to rotate relative to the first member. The second member is connectable to a second display device with a third connector. The third connector is configured and positioned to permit the second display device to rotate relative to the second member. The first member, the second member, the first connector, the second connector and the third connector are configured to permit the second display device to be positioned at a distance from the first display device.

### BRIEF DESCRIPTION OF THE FIGURES

FIG. 1 shows a perspective view of an exemplary embodiment of a dual screen system in a closed position.

FIG. 2 shows a perspective view of an exemplary embodiment of a dual screen system in an open position.

FIGS. 3 and 4 show opposing perspective views of an exemplary embodiment of a dual screen system in an another open position.

FIG. 5 shows a perspective view of an exemplary embodiment of a dual screen system in a further open position.

FIG. 6 shows a perspective view of an exemplary embodiment of a dual screen system in still another open position.

FIG. 7 shows a side view of an exemplary embodiment of the dual screen system.

FIG. 8 shows a side view of an exemplary embodiment of the dual screen system moving between three separate positions.

FIGS. 9 and 10 show side views of an exemplary embodiment of the dual screen system being moved between open positions.

### DETAILED DESCRIPTION OF THE EXEMPLARY EMBODIMENTS

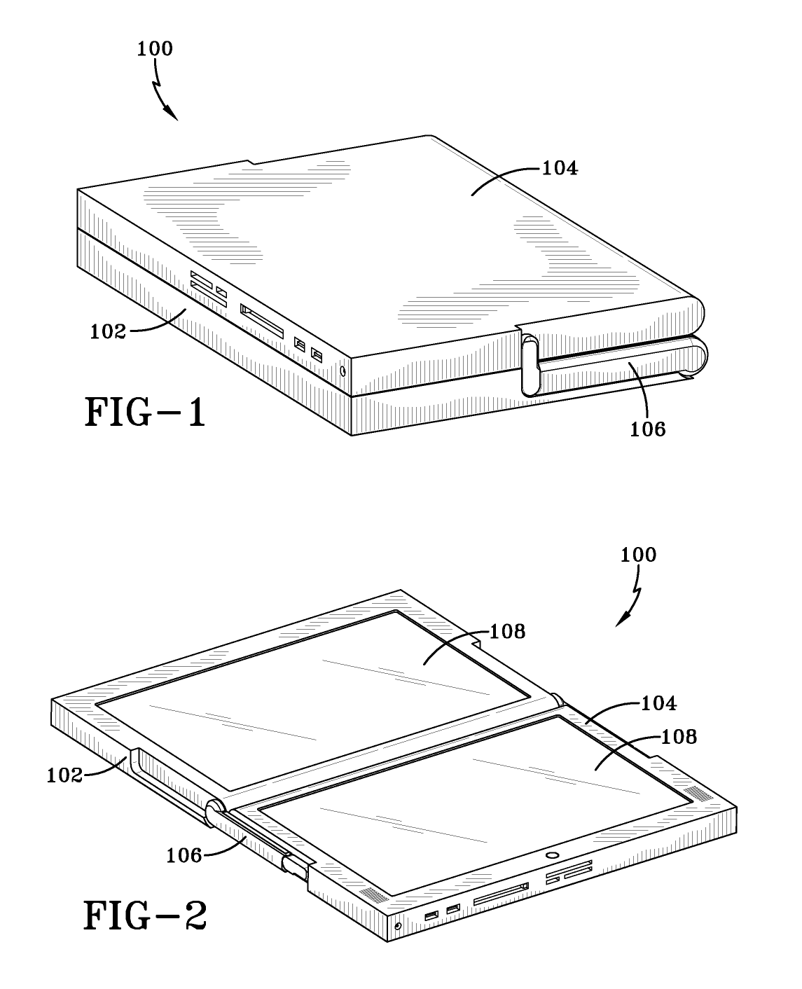

FIGS. 1-6 show one embodiment of a display system in different positions. Display system 100 can include a first display device 102 connected to a second display device 104 by a hinge system 106. Each of the first display device 102 and the second display 104 includes a screen 108. The screen 108 is the portion of the surface area of the corresponding display device on which light patterns, such as characters, shapes, images, lines, etc., are formed for viewing by a user. In one exemplary embodiment, the screens 108 of the display devices 102, 104 can be substantially equal in size. However, in other exemplary embodiments, the screens 108 of the display devices 102, 104 can be of different sizes.

In an exemplary embodiment, one or both of the first display device 102 and the second display device 104 can be operated as a display or monitor that is used to display, on screen 108, a corresponding video signal(s) that may be provided to the display device. The display devices 102, 104 can be any suitable type of flat panel display, e.g., a liquid crystal display (LCD) or a gas plasma display. Further, the display devices 102, 104 may include a LCD that uses technology such as cold cathode fluorescent lamp (CCFL) and/or light emitting diode (LED) for backlighting.

In an exemplary embodiment, the first display device 102 and the second display device 104 can display a common video signal that is provided to one or both of the display devices 102, 104. The common video signal can be provided, using either a wired or wireless connection, to both display devices 102, 104 at the same time or one of the display devices 102, 104 can receive the video signal and then transmit, using either a wired or wireless connection, an appropriate video signal(s) to the other display device. In another exemplary embodiment, each of the first display device and the second display device can receive and display different or independent video signals. The video signal(s) displayed by display devices 102, 104 can be provided from any suitable video source and can include a computer, a computer network, e.g., a local area network, an intranet or the Internet, a video playback device, e.g., a DVD player or video camera, or a direct video source, e.g., a cable or satellite TV connection. The display devices 102, 104 can include corresponding connections (both wired and wireless) in order to receive video signals. Additionally, the display devices 102, 104 may include internal switching devices, logic or functionality to adjust the image on screens 108 for correct viewing between the landscape position and the portrait position based on the orientation of the display devices 102, 104. The internal switching devices, logic or functionality can also invert the image on one or both of screens 108 of the display devices 102, 104 for correct viewing by a user.

In an exemplary embodiment, one or both of the first display device 102 and the second display device 104 can include one or more suitable types of computing devices, e.g., central processing units (CPUs) or microprocessors, an internal power supply and one or more suitable types of memory devices, e.g., random access memory (RAM), read only memory (ROM), flash memory, or internal hard drive. In another exemplary embodiment, the computing devices and memory devices may receive information and data from sources such as flash memory devices, CDs, DVDs, or mini DVDs. The computing devices can execute algorithms or computer programs that are stored in the memory devices to provide the display device with additional processing capabilities in addition to displaying video signals. The inclusion of computing devices and memory devices in a display device can enable the display device to generate video signals that can be displayed by the display device itself and/or displayed by the other display device.

In addition, the display devices 102, 104 can include one or more connections (both wired and wireless) to receive input from other external sources or devices. For example, the display devices 102, 104 can include modem, Ethernet or Firewire ports or connection points to receive and/or transmit information and data over wired connections. In addition, the display devices 102, 104 may also include an antennae and/or transceiver to receive and/or transmit information and data over wireless connections. Further, the display devices 102, 104 can include any suitable type of audio, video or data connection point or port such as microphone ports, audio input ports, external headphone ports, speaker ports, and universal serial bus (USB) ports.

In a further exemplary embodiment, screen 108 of one or both of the display devices 102, 104 can include any suitable touch screen overlay or technology, such as resistive, electromagnetic, or multitouch technologies. The touch screen overlay can be used to provide input capabilities to the display device and can be used by the user to enter and execute commands to be executed by the computing device(s).

In another exemplary embodiment, one or both of the display devices 102, 104 can include port(s) or connection points for electricity and power to be provided to the display device. One or both display devices 102, 104 may have electrical storage capabilities, such as a battery, power cell or capacitor, to store received power or electricity for use at a later time by the display device. The display devices 102, 104 may include one or more external contacts, points, or pads to enable the transfer of electricity and power from one display device to the other display device.

FIG. 1 shows the display system 100 in a closed position. In the closed position, screen 108 of display device 102 faces screen 108 of display device 104. The positioning of screens 108 in a facing position can protect the screens 108 from exterior forces that may damage the screens 108. In an exemplary embodiment, one or both of display devices 102, 104 may include a power switch that can automatically turn off one or both of the display devices 102, 104 when the display system 100 is moved into the closed position.

FIG. 2 shows the display system 100 in an open position with both screens 108 of corresponding display devices being positioned or located substantially in the same plane. The open position of the display system 100 shown in FIG. 2 permits the display system 100 to be placed substantially flat on a surface, either vertically or horizontally, with both screens 108 being viewable by a user.

In an exemplary embodiment, display device 102 and/or display device 104 may be configured to use a Video Electronics Standards Association (VESA) mounting system to mount the display system 100 in a vertical (or horizontal) orientation. One or both displays devices 102, 104 can include a 75 mm or 100 mm hole pattern, which holes may be configured to receive a threaded connector, on the side of the display device(s) opposite the screen 108. The hole pattern is configured and positioned to receive components of a mounting bracket that conforms to the VESA standard. In another exemplary embodiment, display device 102 and/or display device 104 may include a leg (or multiple legs) that can extend from the side of the display device opposite the screen 108 to provide support for a vertically positioned display system 100.

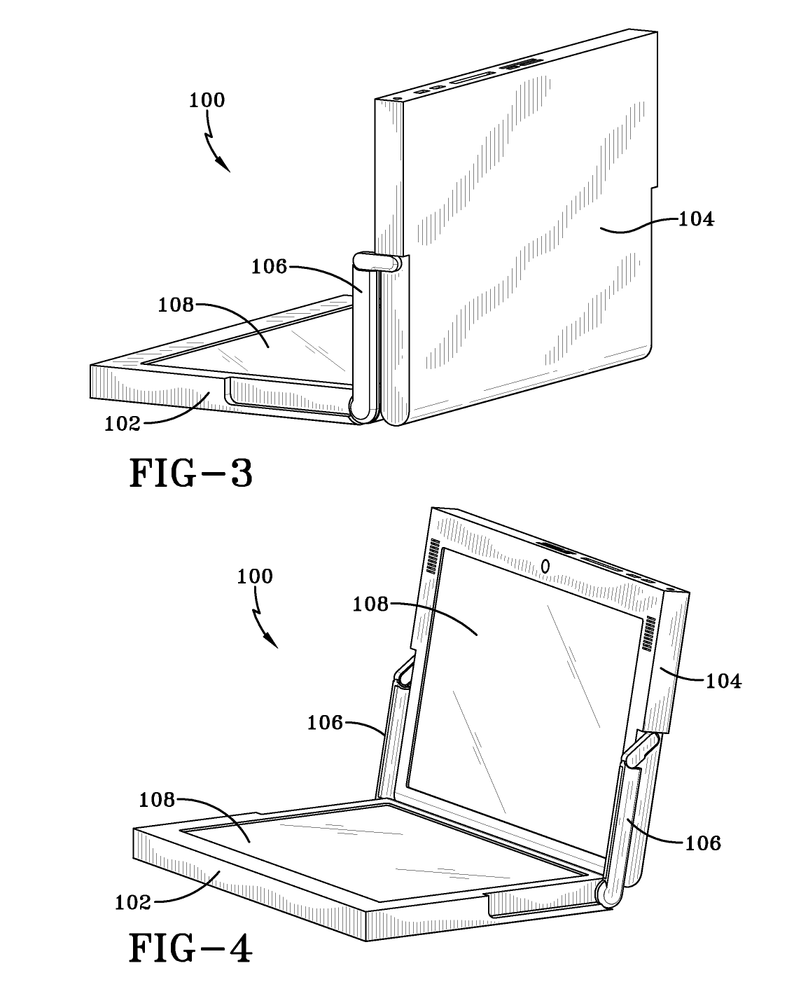

FIGS. 3 and 4 shows the display system 100 in an open position with display device 104 being oriented substantially perpendicular to display device 102. The open position of the display system 100 shown in FIGS. 3 and 4 permits users located on one side of the display system 100 to view both screens 108 and prevents users on the other side of the display system 100 from being able to view either screen 108. In an additional exemplary embodiment, display device 104 can be oriented at an acute angle, i.e., an angle less than 90 degrees, to display device 102. In another exemplary embodiment, display device 104 can be oriented at an obtuse angle, i.e., an angle greater than 90 degrees, to display device 102.

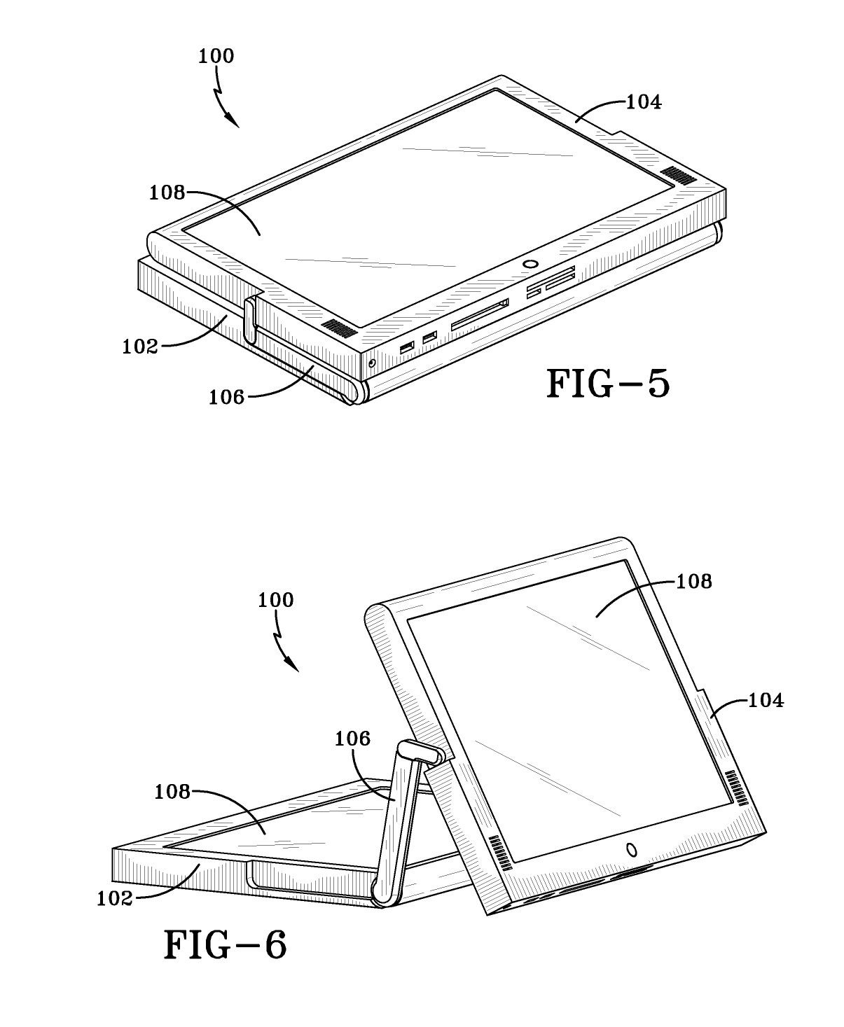

FIG. 5 shows the display system 100 in an open position with screen 108 from display device 104 being positioned above the screen 108 from display device 102. In the open position from FIG. 5, screen 108 from display device 102 is substantially blocked from view by display device 104, thereby rendering screen 108 from display device 102 a non-viewable screen. The open position of display system 100 in FIG. 5 provides a compact footprint while still enabling one of the screens 108 to be viewable (and usable) to a user.

FIG. 6 shows the display system 100 in an open position with display device 104 being positioned separate from display device 102. Screen 108 from display device 104 can be oriented to permit users on the opposite side of display system 100 to display device 102 to be able to view screen 108 of display device 104. In other words, when display device 104 is positioned between a user and display device 102, the user can view screen 108 of display device 104. However, in this position, the users viewing screen 108 of display device 104 would not be able to view screen 108 of display device 102. Similarly, users who are able to view screen 108 of display device 102 would not be able to view screen 108 of display device 104. In other words, when display device 102 is positioned between a user and display device 104, the user can view screen 108 of display device 102, but not screen 108 of display device 104.

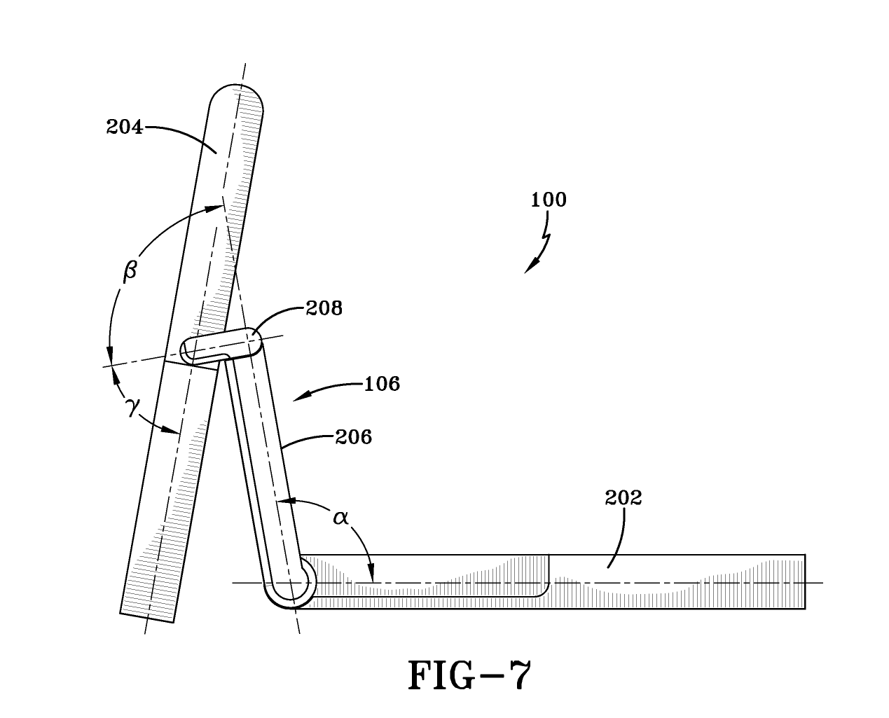

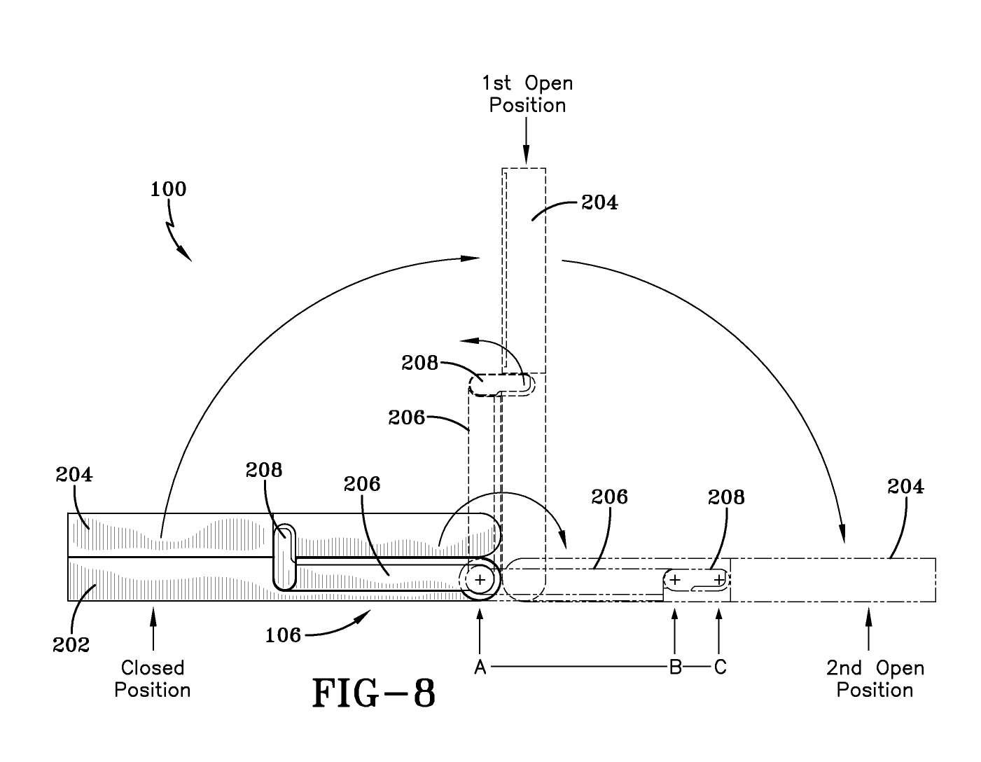

FIG. 7 shows the hinge system 106 of display system 100. As shown in FIG. 7, the display system 100 includes a base unit 202, which corresponds to first display unit 102 of FIGS. 1-6, and a rotatable unit 204, which corresponds to second display unit 104 of FIGS. 1-6. The rotatable unit 204 is connected to the base unit 202 by hinge system 106 that includes a pair of hinges positioned on the sides of each unit. In another exemplary embodiment, hinge system 106 may include only one hinge positioned on one side of the display system 100.

Each hinge has a first arm 206 that is rotatably connected to the base unit 202 by a second arm 208 that is rotatably connected to the rotatable unit 204. The first arm 206 and the second arm 208 are rotatably connected to each other. The first arm 206 can rotate at an angle α relative to the base unit 202. In an exemplary embodiment, the angle α can range from about 0 degrees to about 180 degrees. However, in other exemplary embodiments, the angle α can range from 0 degrees to substantially more or less than 180 degrees. The first arm 206 can be connected to the base unit 202 by any suitable connector, connection technique or connection mechanism that permits rotation of the first arm 206 and can hold or maintain the position of the first arm 206 relative the base unit 202 without the application of any external forces. The positioning of the first arm 206 relative to the base unit 202 can be continuously adjustable along the range of motion of the first arm 206 or the positioning of the first arm 206 relative to the base unit 202 can involve a series of predetermined intermediate positions, e.g., the first arm 206 can be positioned at 5 or 10 degree increments with respect to the base unit 202.

The second arm 208 can rotate at an angle β relative to the first arm 206. In an exemplary embodiment, the angle β can range from about 0 degrees to about 90 degrees. However, in other exemplary embodiments, the angle β can range from 0 degrees to substantially more or less than 90 degrees. In another exemplary embodiment, the angle β can range up to about 100 degrees. The second arm 208 can be connected to the first arm 206 by any suitable connector, connection technique or connection mechanism that permits rotation of the second arm 208 and can hold or maintain the position of the second arm 208 relative the first arm 206 without the application of any external forces. The positioning of the second arm 208 relative to the first arm 206 can be at the ends of the range of motion of the second arm 208 relative to the first arm 206, e.g., the second arm 208 can be positioned only at 0 degrees and 90 degrees, continuously adjustable along the range of motion of the second arm 208, or at a series of predetermined intermediate positions, e.g., the second arm 208 can be positioned at 5 or 10 degree increments with respect to the first arm 206. In a further exemplary embodiment, a spring may be connected internally between the second arm 208 and the first arm 206 to provide additional tensioning between the second arm 208 and the first arm 206 in order to better maintain the relative positioning of the second arm 208 and the first arm 206.

The rotatable unit 204 can rotate at an angle γ relative to the second arm 208. In an exemplary embodiment, the angle γ can range from about 0 degrees to about 180 degrees. However, in other exemplary embodiments, the angle γ can range from 0 degrees to substantially more or less than 180 degrees. In another exemplary embodiment, the angle γ can range up to about 270 degrees. The rotatable unit 204 can be connected to the second arm 208 by any suitable connector, connection technique or connection mechanism that permits rotation of the rotatable unit 204 and can hold or maintain the position of the rotatable unit 204 relative the second arm 208 without the application of any external forces. The positioning of the rotatable unit 204 relative to the second arm 208 can be continuously adjustable along the range of motion of the rotatable unit 204 or the positioning of the rotatable unit 204 relative to the second arm 208 can involve a series of predetermined intermediate positions, e.g., the rotatable unit 204 can be positioned at 5 or 10 degree increments with respect to the second arm 208. The movement of the first arm 206 along angle α, the movement of the second arm 208 along angle β, and the movement of the rotatable unit 204 about angle γ, permit the display devices 102, 104 of display device 100 to be moved into a desired position for use by the user. In an exemplary embodiment, the axes of rotation of associated with angles α, β, and γ are substantially parallel.

In an exemplary embodiment, the first arm 206 can be longer than the second arm 208. However, in other exemplary embodiments the first arm 206 and the second arm 208 can be the same length or the second arm 208 can be longer than the first arm 206. Any changes or adjustments to the lengths of the first arm 206 and the second arm 208 would result in corresponding changes in the connection points to the units and the possible ranges of motion of the first arm 206 and the second arm 208. In still another embodiment, one or more additional arms may be rotatably connected between the first arm 206 and the second arm 208. These additional arms can provide additional positioning options for the base unit 202 and the rotatable unit 204.

FIG. 8 shows the movement of the hinge system 106 of the display system 100 from the closed position to an open position. The base unit 202 and the rotatable unit 204 start in the closed position (see e.g., FIG. 1). In the closed position, the second arm 208 is substantially perpendicular to the first arm 206. The rotatable unit 204 can then be moved to a first open position substantially perpendicular to the base unit 202 (see e.g., FIGS. 3 and 4). When the rotatable unit 204 is moved into the first open position, the first arm 206 is rotated about 90 degrees, while the second arm 208 is maintained in the same position, i.e., the second arm 208 is not rotated. Finally, the rotatable unit 204 is moved to a second open position substantially parallel to the base unit 202 (see e.g., FIG. 2). When the rotatable unit 204 is moved into the second open position, the first arm 206 is rotated about another 90 degrees (about 180 degrees total) and the second arm 208 is rotated about 90 degrees to be substantially coaxial or in alignment with the first arm 206.

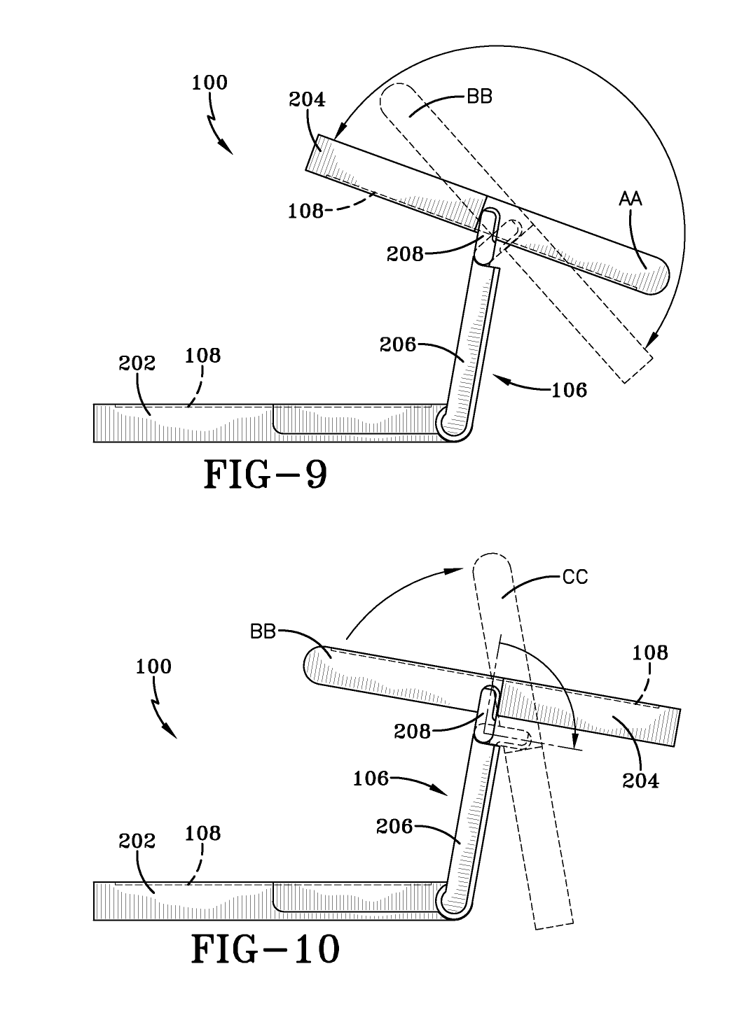

FIGS. 9 and 10 show the movement of the hinge system 106 of the display system 100 between different open positions. The rotatable unit 204 starts in an open position AA relative to the base unit 202 and the first arm 206 and the second arm 208 are substantially coaxial or in alignment. In open position AA, the screen 108 of the rotatable unit 204 is facing the screen 108 of the base unit 202. The rotatable unit 202 can then be rotated about 180 degrees about the second arm 208 into an open position BB. In open position BB, the screen 108 of the rotatable unit 204 is not facing the screen 108 of the base unit 202, i.e., screen 108 of the rotatable unit 204 is opposite the screen 108 of the base unit 202. As shown in FIG. 9, the second arm 208 can be moved to be at an angle less than 90 degrees with respect to first arm 206 for open position BB. However, as shown in FIG. 10, the first arm 206 and the second arm 208 can maintain the same position relative to one another for position BB of the rotatable unit 202. Finally, from position BB, the second arm 208 can be rotated about 90 degrees relative to the first arm 206 to move rotatable unit 204 into open position CC (see e.g., FIG. 6). When the rotatable unit 204 is moved into position CC, the first arm 206 maintains its position and only the second arm 208 is rotated.

Another embodiment is directed to an articulated hinge system for electronic housings/video screens or assemblies. The articulated hinge system uses two two-part hollow articulated hinge arms which allow for electronic wire transfer between the two video screen assemblies. The hinge system can be positioned on two parallel sides of two video screen assemblies which may or may not have additional electronic components in combination with those video screens. The hinge system allows the video screen assemblies to be moved to various positions individually unique to each other. The hinge system is made up of a longer arm attached to one video screen assembly allowing for resistive 180 degree rotation. Attached to the longer arm is a smaller arm whose position can “rest” in one of two positions thereby having 90 degree movement to the longer arm. On the end of this smaller arm is attached the second video screen assembly which has resistive rotation of 180 degrees.

One embodiment relates to a combined system, including an arm system and display devices, that permits a user to manipulate the display devices uniquely and independently of one another to enable the combined system to be configured in multiple positions for “on demand” user applications.

Another embodiment relates to a combined system, including an arm system and display devices, that permits usage of the display devices and then the return of the display devices to a closed position for storage and transport, thereby protecting the display devices.

A further embodiment relates to a combined system, including an arm system and display devices, wherein the arm system is configured to permit wires to travel through the arm system, thereby enabling data, power, information and/or electricity to be transferred between the display devices.

Still another embodiment is related to a combined system, including an arm system and display devices, wherein the display devices can be connected to an information source (e.g., a computer, the Internet or other computer network, such as an intranet), by wire or wirelessly, to receive information that can be displayed either uniquely or severally, i.e., individually on one screen or jointly on both screens, as the user or sender may dictate.

Yet another embodiment is related to an arm system having an arm design that can permit adjustments to measurements A-B, and B-C (see FIG. 8) to accommodate different sizes and thicknesses of display devices.

An additional embodiment is related to display devices that can have an integrated power switch to turn off the display devices when the display devices are returned to the closed position.

Another embodiment is related to a combined system, including an arm system and display devices, that can permit the display devices to be positioned at 180 degrees relative to one another and to be oriented in a landscape or portrait position in a wall or tabletop mode with the use of a Video Electronics Standards Association mounting system. The connection to the mounting system can be achieved by providing a 75 mm or 100 mm hole pattern, which may include threaded holes, on the rear of one or both of the display devices.

A further embodiment is related to a combined system, including an arm system and display devices, wherein the display devices may have internal switching devices, logic or functionality to adjust the image on the screens for correct viewing between the landscape position and the portrait position.

Yet another embodiment relates to a combined system, including an arm system and display devices, that can provide for information transfer by wire or wirelessly to one or both display devices, severally or jointly, to permit the unique usage of information transferred to each display device, and that can enable information to be displayed uniquely on each screen as dictated by the user or source application.

Still another embodiment relates to display devices that can be positioned as shown in FIG. 6 to enable multiple users, or groups of users, to view distinct information in private with respect to the other user or group of users.

An additional embodiment relates to more than one combined system, each including an arm system and display devices, that can be connected either by wire or wirelessly to one another, or that can be connected by wire or wirelessly to a shared or common data or information source to display information collectively, i.e., all screens display the same information, individually, i.e., each screen displays information unique to that screen, or some combination of collectively and individually, i.e., one or more screens display the same information and one or more screens display information unique to that screen.

Another embodiment relates to a combined system, including an arm system and display devices, wherein one or both display devices may include one or more of: central processing units (CPUs) or microprocessors; internal power supplies; or memory devices that can store information received from external sources such as flash memory devices, CDs, DVDs, mini DVDs, or from transmissions over wired connections, e.g., Ethernet or Firewire, or wireless connections.

A further embodiment relates to a combined system, including an arm system and display devices, wherein one or both display devices may include internal memory devices such as random access memory (RAM) and/or read only memory (ROM).

Still another embodiment relates to a combined system, including an arm system and display devices, wherein one or both display devices may include an internal hard drive (memory device).

Yet another embodiment relates to a combined system, including an arm system and display devices, wherein one or both display devices may include liquid crystal display (LCD) screens and/or plasma screens.

An additional embodiment relates to a combined system, including an arm system and display devices, wherein one or both display devices may include LCD screens that utilize backlighting technology such as cold cathode fluorescent lamp (CCFL) and/or light emitting diode (LED).

Another embodiment relates to a combined system, including an arm system and display devices, wherein one or both display devices may include touch screen overlays on one or both screens. The overlay treatments used on the screen(s) may utilize resistive, electromagnetic, or multitouch technology.

A further embodiment relates to a combined system, including an arm system and display devices, wherein one or both display devices may include an Ethernet port to enable Ethernet connectivity.

Still another embodiment relates to a combined system, including an arm system and display devices, wherein one or both display devices may include a Modem port to permit connectivity by way of a modem.

Yet another embodiment relates to a combined system, including an arm system and display devices, wherein one or both display devices may include an antennae or transceiver to enable wireless connectivity.

Another embodiment relates to a combined system, including an arm system and display devices, wherein one or both display devices may include Firewire ports.

A further embodiment relates to a combined system, including an arm system and display devices, wherein one or both display devices may include microphone ports.

Still another embodiment relates to a combined system, including an arm system and display devices, wherein one or both display devices may include audio input ports.

Yet another embodiment relates to a combined system, including an arm system and display devices, wherein one or both display devices may include external headphone ports.

An additional embodiment relates to a combined system, including an arm system and display devices, wherein one or both display devices may include speaker ports.

A further embodiment relates to a combined system, including an arm system and display devices, wherein one or both display device may include one or more universal serial bus (USB) ports.

Still another embodiment relates to a combined system, including an arm system and display devices, wherein one or both display devices may include port(s) or connection points to receive an electrical connection to provide electricity to the display device.

Yet another embodiment relates to a combined system, including an arm system and display devices, wherein one or both display devices may have electrical storage capability such as a battery, power cell or capacitor.

An additional embodiment relates to a combined system, including an arm system and display devices, wherein one or both display devices may have one or more external contacts, points, or pads to enable the transfer of electricity from one display device to the other.

While only certain features and embodiments of the invention have been shown and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Also, two or more steps may be performed concurrently or with partial concurrence. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

What is claimed is:

1. A display system comprising:
a first display device comprising a first screen;
a second display device comprising a second screen;
a hinging system connecting the first display device and the second display device, the hinging system comprising:
a first member connected to the first display device, the first member being configured to rotate relative to the first display device;
a second member having a first end and a second end opposite the first end, the second member being connected to the first member at the first end and the second member being connected to the second display device at the second end;
the second member being configured to rotate relative to the first member; and
the second display device being configured to rotate relative to the second member; and
the hinging system being configured and positioned to permit the second display device to rotate independently of the first display device.

2. The display system of claim 1 wherein the first member is configured to rotate about 180 degrees relative to the first display device.

3. The display system of claim 1 wherein the second member is configured to rotate about 90 degrees relative to the first member.

4. The display system of claim 1 wherein the second display device is configured to rotate about 180 degrees relative to the second member.

5. The display system of claim 1 wherein the first member comprises a first passageway and the second member comprises a second passageway, the first and second passageways are configured to receive a wire connecting the first display device and the second display device.

6. The display system of claim 1 wherein a spring connects the first member and the second member.

7. The display system of claim 1 wherein at least one of the first display device or the second display device comprises at least one hole to permit mounting of the display system in a vertical orientation.

8. The display system of claim 1 wherein the hinging system is configured and positioned to maintain the position of the first display device relative to the second display device.

9. The display system of claim 1 wherein at least one of the first screen or the second screen comprises a touch screen overlay.

10. A system to connect a first display device to a second display device comprising:
a first member being connectable to a first display device with a first connector, the first connector being configured and positioned to permit the first member to rotate relative to the first display device;
a second member connected to the first member with a second connector, the second connector being configured and positioned to permit the second member to rotate relative to the first member;
the second member being connectable to a second display device with a third connector, the third connector being configured and positioned to permit the second display device to rotate relative to the second member; and
wherein the first member, the second member, the first connector, the second connector and the third connector are configured to permit the second display device to be positioned at a distance from the first display device.

11. The system of claim 10 wherein the first connector is configured and positioned to permit the first member to rotate about 180 degrees relative to the first display device.

12. The system of claim 10 wherein the first connector is configured and positioned to maintain the position of the first member relative to the first display device.

13. The system of claim 10 wherein the second connector is configured and positioned to permit the second member to rotate about 90 degrees relative to the first member.

14. The system of claim 10 wherein the second connector is configured and positioned to maintain the position of the second member relative to the first member.

15. The system of claim 10 wherein the third connector is configured and positioned to permit the second display device to rotate about 180 degrees relative to the second member.

16. The system of claim 10 wherein the third connector is configured and positioned to maintain the position of the second display device relative to the second member.

17. The system of claim 10 wherein the first member comprises a first passageway and the second member comprises a second passageway, the first and second passageways being configured to protect a wire connecting the first display device and the second display device.

18. The system of claim 10 further comprising a spring connecting the first member and the second member.
